(19) United States
(12) Patent Application Publication
(10) Pub. No.: US 2025/0099898 A1
(43) Pub. Date: Mar. 27, 2025

(54) ADSORPTION UNIT HAVING SPACER PIECES

(71) Applicant: DELTA ELECTRONICS, INC., Taoyuan City (TW)

(72) Inventors: Chin-Chun LAI, Taoyuan City (TW); Po-Cheng KUNG, Taoyuan City (TW); Li-Chia CHEN, Taoyuan City (TW); Kun-Fu CHUANG, Taoyuan City (TW); Chia-Feng WU, Taoyuan City (TW)

(21) Appl. No.: 18/895,892

(22) Filed: Sep. 25, 2024

Related U.S. Application Data
(60) Provisional application No. 63/540,640, filed on Sep. 26, 2023.

(51) Int. Cl. B01D 53/04

(52) U.S. Cl. CPC B01D 53/0407; B01D 2257/504

(57) ABSTRACT

This disclosure is directed to an adsorption unit, having a frame, multiple spacer pieces and multiple adsorption structures. The frame has an inlet side and an exhaust side. The spacer pieces are arranged in the frame. The adsorbed structures are arranged in the frame, and are restricted by the spacers and fixed in the frame so as to locate between the inlet side and the exhaust side. Air enters the adsorption unit from the environment through the inlet side, passes through the adsorption unit, and leaves the adsorption unit through the exhaust side. The air passes through the adsorption unit and returns to the environment so as to contact the adsorption structures to remove carbon dioxide and water.

### CROSS-REFERENCE TO RELATED APPLICATION

This patent application claims the benefit of U.S. Provisional Patent Application No. 63/540,640, filed Sep. 26, 2023, which is incorporated by reference herein.

### BACKGROUND OF THE INVENTION

### Technical Field

This disclosure is directed to a system of carbon capture, utilization and storage (CCUS), in particular to an adsorption unit for capturing carbon dioxide from ambient air.

### Description of Related Art

Adsorption gas separation is a commonly used industrial method. In recent years, in order to achieve climate protection goals, methods for removing CO₂ (carbon dioxide) from industrial waste gases or the atmosphere, especially the latter method called direct air capture (DAC), have applied favorable energy sources and related processing infrastructure, there are many previous cases to reduce carbon dioxide emissions into the atmosphere, thereby reducing the greenhouse effect.

Carbon capture, utilization and storage (CCUS) system involves the capture of carbon dioxide, generally from large point sources such as power generation or industrial facilities that use either fossil fuels or biomass as fuel. CCUS can tackle emissions in hard-to-abate sectors, particularly heavy industries like cement, steel, or chemicals. CCUS is an enabler of least-cost low-carbon hydrogen production, which can support the decarbonization of other parts of the energy system, such as industry, trucks, and ships. CCUS can remove carbon dioxide from the air to balance emissions that are unavoidable or technically difficult to abate.

Accordingly, providing an adsorption unit that can efficiently capture carbon dioxide from ambient air is an important issue in the art.

### SUMMARY OF THE INVENTION

This disclosure is directed to an adsorption unit 11 for capturing carbon dioxide from ambient air.

This disclosure is directed to an adsorption unit having a frame, multiple spacer pieces and multiple adsorption structures. The frame has an inlet side and an exhaust side. The spacer pieces are arranged in the frame. The adsorption structures are arranged in the frame, and the adsorption structures are restricted by the spacer pieces to be fixed in the frame and between the inlet side and the exhaust side. In one of the exemplary embodiments, a first space is defined between the frame and the spacer pieces, and the adsorption structures are disposed in the first space.

In one of the exemplary embodiments, each of the spacer pieces has a second space defined therein, and the adsorption structures are disposed in the second spaces, respectively.

In one of the exemplary embodiments, the frame has a plurality of sealing plates, the sealing plates are annually arranged and connected between the inlet side and the exhaust side, and each of the spacer pieces is arranged to cross the inlet side and cross the exhaust side.

In one of the exemplary embodiments, two of the spacer pieces are disposed as a set, in each of the sets, the spacer pieces are sealed with each other at a periphery to form a bag so that the spacer pieces are separated from each other in an area enclosed by the periphery.

In one of the exemplary embodiments, the adsorption structures are made of adsorption material and disposed on the spacer pieces, respectively, and the adsorption material is molecular sieve.

In one of the exemplary embodiments, the adsorption structures are granules made of adsorption material, and the adsorption material is molecular sieve.

In one of the exemplary embodiments, the spacer pieces are fixed in the frame, each of the spacer piece has a periphery connected to the frame.

In one of the exemplary embodiments, the spacer pieces are substantially parallel to each other and separated from each other.

In one of the exemplary embodiments, each of the spacer pieces is made of aluminum or alloy thereof.

In one of the exemplary embodiments, each of the spacer pieces has a plurality of pores.

The air enters the adsorption unit from the environment through the inlet side, then passes through the adsorption unit and exits the adsorption unit through the exhaust side. The ambient air is contacted with the adsorption structures when passing through the adsorption unit, so that the carbon dioxide and water carried therein are adsorbed by the adsorption structures. A part of the carbon dioxide and water contained in the air is removed in the adsorption unit, and then the air is exhausted from the adsorption unit through the exhaust side and returned to the environment.

According to this disclosure, the adsorption unit has a frame for limiting a flow direction of the airflow, and the adsorption unit further has spacer pieces arranged in the frame. The adsorption structures are arranged along the flow direction of the airflow via the spacer pieces so that the air is contacted with the adsorption structures in a longer period when passing through the adsorption unit, and carbon dioxide and water are therefore adsorbed from the air more efficiently by the adsorption structures.

### BRIEF DESCRIPTION OF THE DRAWINGS

The features of the disclosure believed to be novel are set forth with particularity in the appended claims. The disclosure itself, however, may be best understood by reference to the following detailed description of the disclosure, which describes a number of exemplary embodiments of the disclosure, taken in conjunction with the accompanying drawings, in which:

FIG. 1 is a perspective view showing an adsorption module and adsorption units thereof according to this disclosure;

FIG. 2 is an exploded view showing the adsorption unit according to the first embodiment of this disclosure;

FIG. 3 is a perspective view showing the adsorption unit according to the first embodiment of this disclosure;

FIG. 4 is a cross-sectional view of the adsorption unit crossing a passing direction of airflow according to the first embodiment of this disclosure;

FIG. 5 is a cross-sectional view of the adsorption unit along a passing direction of airflow according to the first embodiment of this disclosure;

FIG. 6 is a perspective view showing an adsorption unit according to the second embodiment of this disclosure;

FIG. 7 is a perspective view showing the adsorption unit according to the third embodiment of this disclosure; and

FIG. 8 is a perspective view showing the adsorption unit according to the fourth embodiment of this disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

Detailed descriptions and technical contents of this disclosure is described in the flowing paragraph with reference to the drawings. However, the drawings are attached only for illustration and are not intended to limit this disclosure.

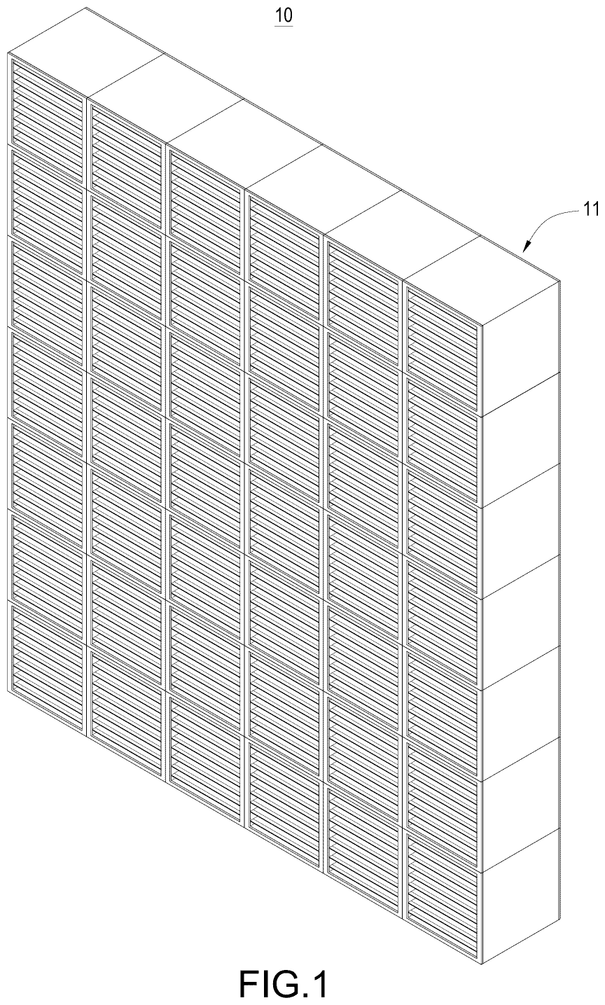

According to an adsorption unit 11 and an adsorption module 10 of this disclosure as shown in FIG. 1, in order to reduce the greenhouse effect, this disclosure provides an adsorption unit 11 with an adsorption unit for capturing carbon dioxide. Accordingly, this disclosure is directed to an adsorption unit 11 for capturing carbon dioxide from ambient air. The ambient air recited in this disclosure may be industrial waste gas or atmosphere containing carbon dioxide.

According to this disclosure, the molecular sieve is used as an adsorption material for adsorbing carbon dioxide or water. The adsorption material is a powdery adsorption material in original, and the powdery adsorption material is sintered into a granular adsorbent material applied in the adsorption unit 11 of this disclosure.

The molecular sieve is a solid chemical functionalized adsorbent material, which is suitable for adsorbing carbon dioxide with a concentration of approximately 400 ppm. The Molecular sieve adsorbs carbon dioxide and water at room temperature namely between 25° C. and 35° C. The adsorption efficiency decreases with a temperature increasing, and the molecular sieve stops adsorbing and begins to desorb at a temperature higher than 60° C.

The molecular sieve has at least the components of K₂O (potassium oxide), CaO (calcium oxide), Al₂O₃ (aluminum oxide), SiO₂ (silicon dioxide) and Na₂O (sodium oxide). The melting point of the molecular sieve is approximately 2230° C. The particles of the molecular sieve have a density within 0.65-0.8 g/cm³.

This disclosure provides an adsorption unit 11 having granules of the adsorption material. A plurality of adsorption units 11 are disposed in a stack and defined as an adsorption module 10. The adsorption module 10 further has a rack as a structure for supporting the stacked adsorption units 11. The adsorption module 10 is suitable for an adsorption process in a room temperature environment and a desorption process in a high temperature environment. The adsorption material can adsorb carbon dioxide and water at the same time, considering this, a plurality of adsorption modules 10 are used cooperatively to improve adsorptions of water and carbon dioxide and result in a higher concentration of carbon dioxide adsorbed in the adsorption modules 10.

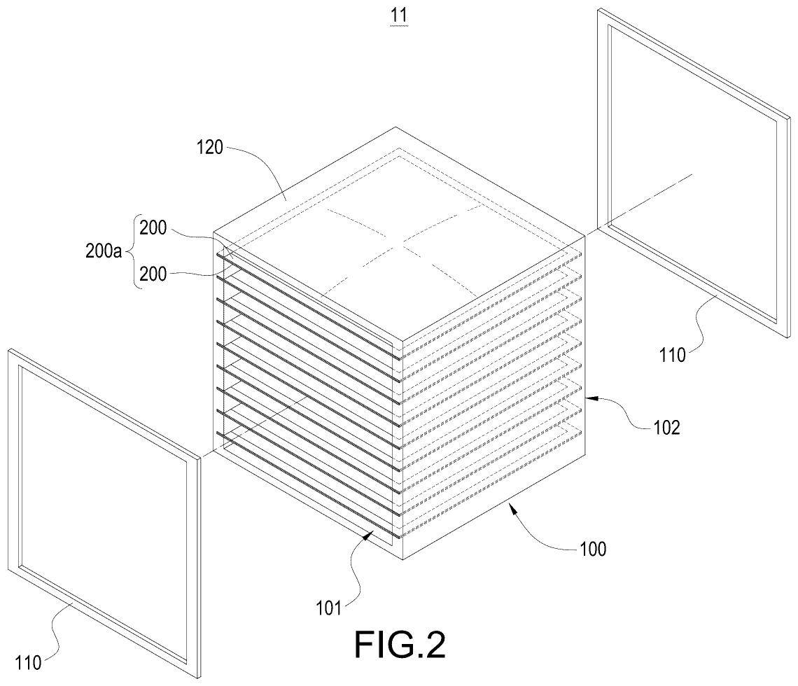

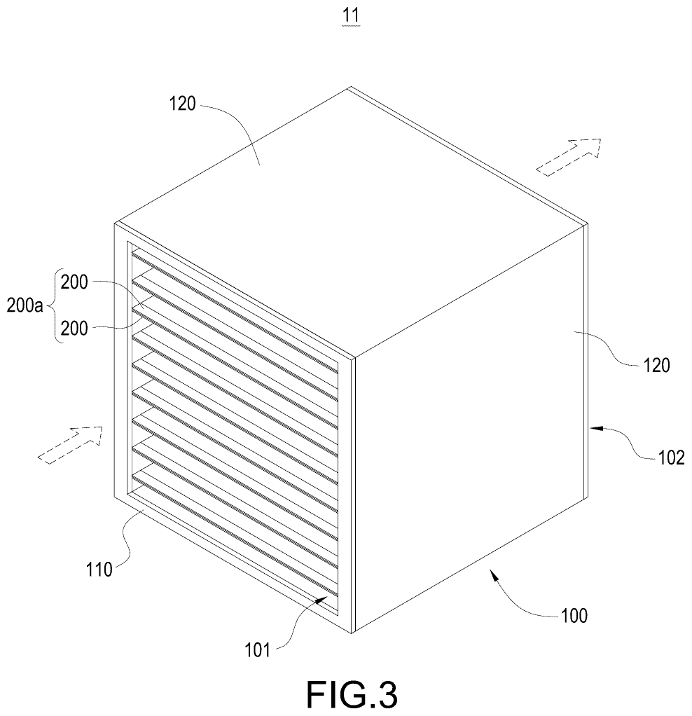

FIG. 2 is an exploded view showing the adsorption unit 11 according to the first embodiment of this disclosure, and FIG. 3 is a perspective view showing the adsorption unit 11 according to the first embodiment of this disclosure. According to the first embodiment of this disclosure as shown in FIGS. 2 and 3, an adsorption unit 11 having a frame 100 and a plurality of spacer pieces 200 is provided.

Referring to FIGS. 2 and 3, in this embodiment, the frame 100 has an inlet side 101 and an exhaust side 102. The inlet side 101 and the exhaust side 102 are open and opposite to each other, and the rest portions of the frame 100 are closed. Specifically, the frame 100 has a pair of communicating plates 110 and a plurality of sealing plates 120. The communicating plates 110 are defined with holes so as to be open. The pair of communicating plates 110 are arranged at the inlet side 101 and the exhaust side 102, respectively, so that the inlet side 101 and the exhaust side 102 are open, and the sealing plates 120 are arranged to surround the pair of communication plates 110. The sealing plates 120 are connected between the inlet side 101 and the exhaust side 102 to seal the rest portions of the frame 100.

Then referring to FIGS. 2 and 3, according to this embodiment, each of the spacer pieces 200 is a film with pores allowing the air to pass. The spacer pieces 200 may be cloth, paper, plastic film or mesh, but the scopes of this disclosure should not be limited to this. The spacer pieces 200 are arranged in the frame 100, and the spacer pieces 200 are substantially parallel to each other and separated from each other. Specifically, two of the spacer pieces 200 are disposed as a set. In each of the sets, the spacer pieces 200 are sealed with each other at a periphery so that the spacer pieces 200 are separated from each other in an area enclosed by the periphery with a gap within 3.5 mm to 6 mm. In other words, each set of pieces together forms a bag 200a.

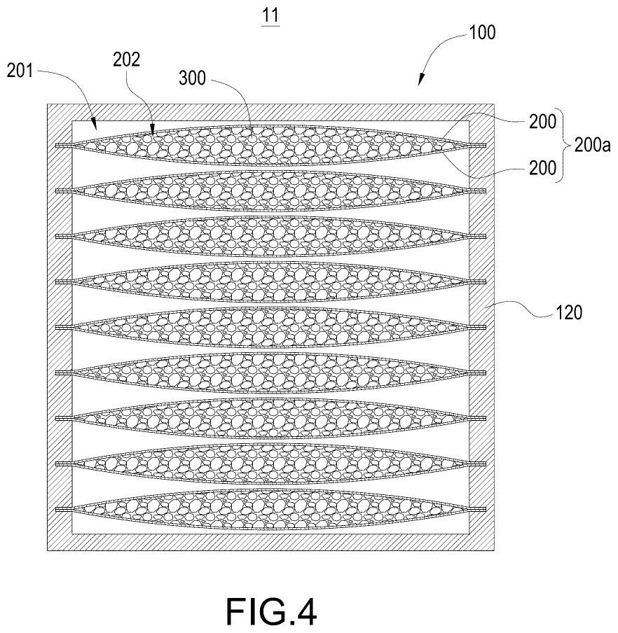

FIG. 4 is a cross-sectional view of the adsorption unit crossing a passing direction of airflow according to the first embodiment of this disclosure. Referring to FIGS. 3 and 4, in this embodiment, the bags 200a are arranged in a stack arranged in the frame 100, and each of the bags 200a is substantially parallel to the passing direction of airflow. The periphery of each bag 200a is embedded into a pair of sealing plates 120 of the frame 100 which are opposite to each other, but the scopes of this disclosure should not be limited to this. A first space 201 is defined between the frame 100 and the bags 200a, and each of the bags 200a is defined with a second space 202 between two of the spacer pieces 200 thereof.

Referring to FIG. 3 and FIG. 4, the adsorption structures 300 are granules made of the adsorption material, and the adsorption material is molecular sieve. Accordingly, the adsorption structures 300 are arranged in the frame 100 and restricted by the spacer pieces 200 to be fixed in the frame 100 between the inlet side 101 and the exhaust side 102. Each of the granules made of the adsorption material is a granule larger than the pores 211 of the spacer pieces 200. In this embodiment, the adsorption structures 300 are arranged in the second spaces 202. The first space 201 is defined as a flow channel communicated between the inlet side 101 and the exhaust side 102.

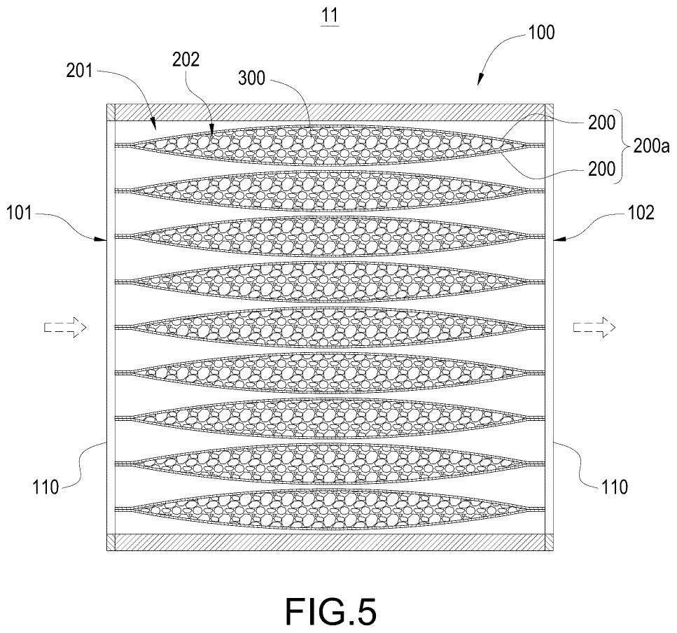

FIG. 5 is a cross-sectional view of the adsorption unit 11 along a passing direction of airflow according to the first embodiment of this disclosure. Referring to FIG. 5, the air enters the adsorption unit 11 from the environment through the inlet side 101, then passes through the adsorption unit 11 and exits the adsorption unit 11 through the exhaust side 102. The ambient air enters the bags via the pores to contact with the adsorption structures 300 when passing through the adsorption unit 11, so that the carbon dioxide and water carried therein are adsorbed by the adsorption structures 300. A part of the carbon dioxide and water contained in the air is removed in the adsorption unit 11, and then the air is exhausted from the adsorption unit 11 through the exhaust side 102 and returned to the environment.

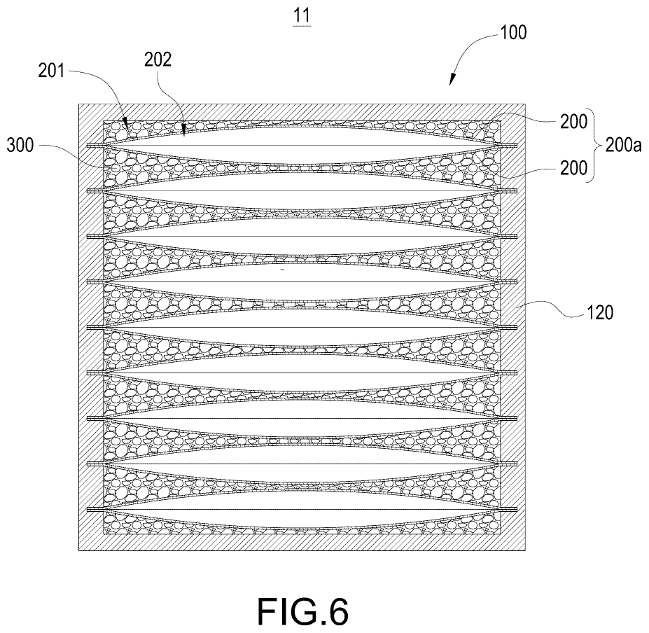

Referring to an adsorption unit 11 according to the second embodiment of this disclosure as shown in a schematic view of FIG. 6, an adsorption unit 11 having a frame 100, a plurality of spacer pieces 200, and a plurality of adsorption structures 300 is provided.

Also referring to FIG. 2, in this embodiment, the frame 100 and the spacer pieces 200 have structures the same as that of the first embodiment. In other words, the frame 100 has an inlet side 101 and an exhaust side 102, the inlet side 101 and the exhaust side 102 are open, and the rest portions of the frame 100 are closed. Specifically, the frame 100 has a pair of communicating plates 110 and a plurality of sealing plates 120. The communicating plates 110 are defined with holes so as to be open. The pair of communicating plates 110 are arranged at the inlet side 101 and the exhaust side 102, respectively, so that the inlet side 101 and the exhaust side 102 are open, and the sealing plates 120 are arranged to surround the pair of communication plates 110. The sealing plates 120 are connected between the inlet side 101 and the exhaust side 102 to seal the rest portions of the frame 100.

Each of the spacer pieces 200 is a film with pores (not shown in figures) allowing the air to pass. The spacer pieces 200 may be cloth, paper, plastic film or mesh, but the scopes of this disclosure should not be limited to this. The spacer pieces 200 are arranged in the frame 100, and the spacer pieces 200 are substantially parallel to each other and separated from each other. Specifically, two of the spacer pieces 200 are disposed as a set. In each of the sets, the spacer pieces 200 are sealed with each other at a periphery so that the spacer pieces 200 are separated from each other in an area enclosed by the periphery with a gap within 3.5 mm to 6 mm. In other words, each set of pieces together forms a bag 200a.

Referring to FIG. 6, in this embodiment, the bags 200a are arranged in a stack configures in the frame 100, and each of the bags 200a is substantially parallel to the passing direction of airflow. A first space 201 is defined between the frame 100 and the bags 200a, and each of the bags 200a is defined with a second space 202.

Referring to FIG. 6, the adsorption structures 300 are granules made of the adsorption material, and the adsorption material is molecular sieve. Each of the granules made of the adsorption material is a granule larger than the pores 211 of the spacer pieces 200. Accordingly, the adsorption structures 300 are arranged in the frame 100 and restricted by the spacer pieces 200 to be fixed in the frame 100 between the inlet side 101 and the exhaust side 102. According to this embodiment, the adsorption structures 300 are disposed in the first space 201, and the second spaces 202 are defined as a flow channel communicated between the inlet side 101 and the exhaust side 102.

Accordingly, air enters the adsorption unit 11 from the environment through the inlet side 101 and is discharged from the adsorption unit 11 through the exhaust side 102 after passing through the flow channel. The ambient air is contacted with the adsorption structures 300 via the pores of the spacer pieces 200 when passing through the flow channel, so that carbon dioxide and water carried in the ambient air are adsorbed by the adsorption structures 300. A portion of carbon dioxide and water is removed from the air in the flow channel, and then the air is discharged from the adsorption unit 11 through the exhaust side 102 and returned to the environment.

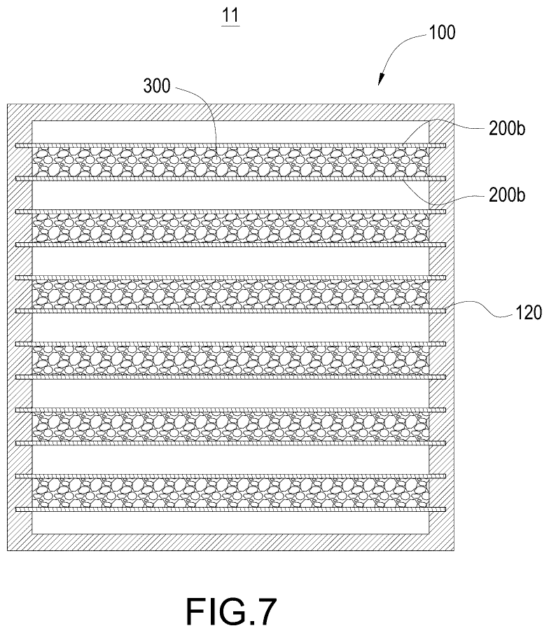

According to the third embodiment of this disclosure as shown in FIG. 7, an adsorption unit 11 having a frame 100, a plurality of spacer pieces 200b and a plurality of adsorption structures 300 is provided.

Also referring to FIG. 2, in this embodiment the frame 100 has a structure the same as the first embodiment. In other words, the frame 100 has an inlet side 101 and an exhaust side 102, the inlet side 101 and the exhaust side 102 are open, and the rest portions of the frame 100 are closed. Specifically, the frame 100 has a pair of communicating plates 110 and a plurality of sealing plates 120. The communicating plates 110 are defined with holes so as to be open. The pair of communicating plates 110 are arranged at the inlet side 101 and the exhaust side 102, respectively, so that the inlet side 101 and the exhaust side 102 are open, and the sealing plates 120 are arranged to surround the pair of communication plates 110. The sealing plates 120 are connected between the inlet side 101 and the exhaust side 102 to seal the rest portions of the frame 100.

According to this embodiment as shown in FIG. 7, each of the spacer pieces 200b is a flat piece such as cloth, paper, plastic film or plate which may made of aluminum of alloy thereof, but the scopes of this disclosure should not be limited to this. The spacer pieces 200b are arranged in the frame 100, and the spacer pieces 200b are substantially parallel to each other and separated from each other. Specifically, a periphery of each spacer piece 200b is fixed with the frame 100 so that the spacer pieces 200b are positioned in the frame and the spacer pieces 200b are separated from each other with a gap within 3.5 mm to 6 mm. According to various passing direction of airflow, each of the spacer pieces 200b may be disposed with a plurality of pores (not shown in the figures) allowing air to pass, or each of the spacer pieces 200b may be disposed without pore. According to one example, if the spacer pieces 200b are arranged parallel to the passing direction of airflow, each spacer 200b is be disposed without pores. According to another example, if the spacer 200b are arranged perpendicular to the passing direction of airflow, each spacer piece 200b is disposed with pores allowing the airflow to pass through the spacer pieces 200b.

The adsorption structures 300 are granules made of the adsorption material, and the adsorption material is molecular sieve. The adsorption structures 300 are disposed in the frame 100, and the adsorption structures 300 are filled between two of the spacer pieces 200b and restricted by the spacer pieces 200b to be fixed in the frame 100 between the inlet side 101 and the exhaust side 102. Each of the adsorption structures 300 is a granule larger than the pores of the spacer pieces 200.

Accordingly, air enters the adsorption unit 11 from the environment through the inlet side 101 and is discharged from the adsorption unit 11 through the exhaust side 102 after passing through the flow channel. The ambient air is contacted with the adsorption structures 300 when passing through the flow channel, so that carbon dioxide and water carried in the ambient air are adsorbed by the adsorption structures 300. A portion of carbon dioxide and water is removed from the air in the flow channel, and then the air is discharged from the adsorption unit 11 through the exhaust side 102 and returned to the environment.

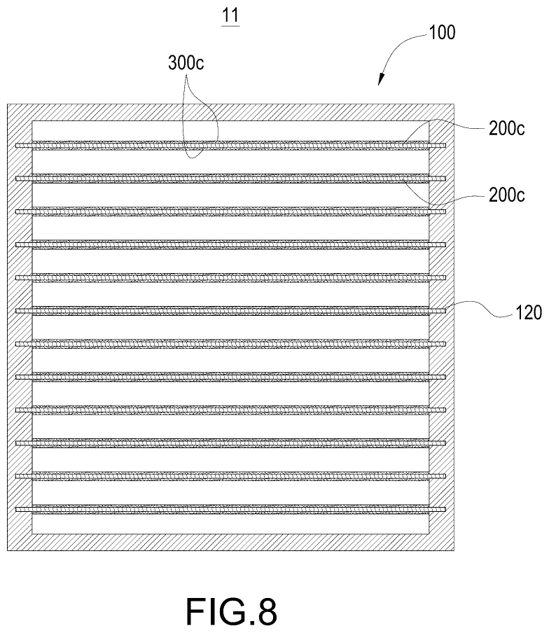

According to the fourth embodiment of this disclosure as shown in FIG. 8, an adsorption unit 11 having a frame 100, a plurality of spacer pieces 200c and a plurality of adsorption structures 300c is provided.

Also referring to FIG. 2, in this embodiment, the frame 100 and the spacer pieces 200 have structures the same as that of the first embodiment. In other words, the frame 100 has an inlet side 101 and an exhaust side 102. The inlet side 101 and the exhaust side 102 are open, and the rest portions of the frame 100 are closed. Specifically, the frame 100 has a pair of communicating plates 110 and a plurality of sealing plates 120. The communicating plates 110 are defined with holes so as to be open. The pair of communicating plates 110 are arranged at the inlet side 101 and the exhaust side 102, respectively, so that the inlet side 101 and the exhaust side 102 are open, and the sealing plates 120 are arranged to surround the pair of communication plates 110. The sealing plates 120 are connected between the inlet side 101 and the exhaust side 102 to seal the rest portions of the frame 100.

According to this embodiment as shown in FIG. 8, each of the spacer pieces 200c is a flat piece such as cloth, paper, plastic film or plate which may made of aluminum of alloy thereof, but the scopes of this disclosure should not be limited to this. The spacer pieces 200c are arranged in the frame 100, and the spacer pieces 200c are substantially parallel to each other and separated from each other. Specifically, a periphery of each spacer piece 200c is fixed with the frame 100 so that the spacer pieces 200c are positioned in the frame and the spacer pieces 200c are separated from each other with a gap within 3.5 mm to 6 mm. According to various passing direction of airflow, each of the spacer pieces 200c may be disposed with a plurality of pores (not shown in the figures) allowing air to pass, or each of the spacer pieces 200c may be disposed without pore. According to one example, if the spacer pieces 200c are arranged parallel to the passing direction of airflow, each spacer piece 200c is disposed without pores. According to another example, if the spacer pieces 200c are arranged perpendicular to the passing direction of airflow, each spacer piece 200c is disposed with pores allowing the airflow to pass through the spacer pieces 200c.

The adsorption structures 300 are made of adsorption material and disposed on the spacer pieces 200c, respectively, and the adsorption material is molecular sieve. The adsorbent material may be disposed on the spacer pieces 200c by spraying or sintering, so that adsorbent material is located between the inlet side 101 and the exhaust side 102.

Accordingly, air enters the adsorption unit 11 from the environment through the inlet side 101 and is discharged from the adsorption unit 11 through the exhaust side 102 after passing through the flow channel. The ambient air is contacted with the adsorption structures 300c when passing through the flow channel, so that carbon dioxide and water carried in the ambient air are adsorbed by the adsorption structures 300c. A portion of carbon dioxide and water is removed from the air in the flow channel, and then the air is discharged from the adsorption unit 11 through the exhaust side 102 and returned to the environment.

According to this disclosure, the adsorption unit has a frame for limiting a flow direction of the airflow, and the adsorption unit further has spacer pieces arranged in the frame. The adsorption structures are arranged along the flow direction of the airflow via the spacer pieces so that the air is contacted with the adsorption structures in a longer period when passing through the adsorption unit, and carbon dioxide and water are therefore adsorbed from the air more efficiently by the adsorption structures.

While this disclosure has been described by means of specific embodiments, numerous modifications and variations could be made thereto by those skilled in the art without departing from the scope and spirit of this disclosure set forth in the claims.

What is claimed is:

1. An adsorption unit, comprising:
a frame, comprising an inlet side and an exhaust side;
a plurality of spacer pieces, arranged in the frame, and
a plurality of adsorption structures, arranged in the frame, and the adsorption structures restricted by the spacer pieces to be fixed in the frame and between the inlet side and the exhaust side.

2. The adsorption unit according to claim 1, wherein a first space is defined between the frame and the spacer pieces, and the adsorption structures are disposed in the first space.

3. The adsorption unit according to claim 1, wherein each of the spacer pieces comprises a second space defined therein, and the adsorption structures are disposed in the second spaces, respectively.

4. The adsorption unit according to claim 3, wherein the frame comprises a plurality of sealing plates, the sealing plates are annually arranged and connected between the inlet side and the exhaust side, and each of the spacer pieces is arranged to cross the inlet side and cross the exhaust side.

5. The adsorption unit according to claim 1, wherein two of the spacer pieces are disposed as a set, in each of the sets, the spacer pieces are sealed with each other at a periphery to form a bag so that the spacer pieces are separated from each other in an area enclosed by the periphery.

6. The adsorption unit according to claim 1, wherein the adsorption structures are made of adsorption material and disposed on the spacer pieces, respectively, and the adsorption material is molecular sieve.

7. The adsorption unit according to claim 1, wherein the adsorption structures are granules made of adsorption material, and the adsorption material is molecular sieve.

8. The adsorption unit according to claim 1, wherein the spacer pieces are fixed in the frame, each of the spacer piece comprises a periphery connected to the frame.

9. The adsorption unit according to claim 1, wherein the spacer pieces are substantially parallel to each other and separated from each other.

10. The adsorption unit according to claim 1, wherein each of the spacer pieces is made of aluminum or alloy thereof.

11. The adsorption unit according to claim 1, wherein each of the spacer pieces comprises a plurality of pores.
